(19) United States
(12) Patent Application Publication
(10) Pub. No.: US 2008/0307658 A1
(43) Pub. Date: Dec. 18, 2008

(54) Scissors with a blade having a tapered center for hinge

(76) Inventor: Dong Ho Jun, Santa Ana, CA (US)

Correspondence Address: Eugene OAK, Ph.D., J,D., M.Div.;Law Office of Jane OAK & Associates P.C., Suit 2470, 3435 Wilshire Blvd., Los Angeles, CA, 90010, US

(21) Appl. No.: 11/811,663

(22) Filed: Jun. 12, 2007

(51) Int. Cl. B26B 13/00

(52) U.S. Cl. 30/255; 30/341

(57) ABSTRACT

A scissors is provided. The scissors according to current application has a specially designed first blade. The specially designed first blade has a tapered bump at the central part, on which a hinge hole is developed. The tapered bump on the first blade allow the second blade of the scissors to cross over the first blade with an angle. Therefore, the second blade's wide edge crosses over the first blade's wide edge with an angle and sweeps wide surface of the first blade with an angle. Such angled cross over of the blades provides a more precise cut of customer's hair as a barber intended.

### FIELD OF THE INVENTION

Current application relates to a scissors, especially to a scissors equipped with a blade that has a tapered center for hinge to provide a more precise hair cut as a barber intends.

### BACKGROUND OF THE INVENTION

Almost all of scissors developed up to now have blades that cross over each other without angle. Two blades of scissors overlap each other without any space between them from the first moment when the scissors is open to the last moment when the scissors is closed. Therefore, friction force between the two blades is maximum. It burdens a barber's finger to overcome the friction between the blades. If some gap is formed intently to reduce the friction force between the blades, hairs of a customer are inserted between the gaps. Then the hairs are not cut clearly or are not cut at all. Adding some lubricant to the blades may reduce the friction force but not desirable for human hair cut. It is a purpose of the current application to provide a human hair cutting scissors that causes less friction force between two blades than previous scissors by introducing one blade, which a central part that is tapered along the narrow axis of the blade and a hinge hole is developed thereon. The scissors according to current application enables a more clear cut of a human hair than scissors of prior art.

### DESCRIPTION OF PRIOR ART

U.S. Patent Application 20050209624 to Vijay, Venkataramana illustrates a surgical scissors includes two cutting blades operable via a handle. One of the blades is provided with a distally projecting needle-like tip which can easily pierce tissue. In use, the tip on the blade is gently pressed against a vessel, preferably at a shallow angle relative to the vessel, to define an entry hole. U.S. Patent Application 20040098007 to Heiss, Frederick W. illustrates a biliary sphincter scissors, used in a sphincterotomy; include a stationary blade and an actuated blade having dimensions which allow the scissors to pass through a channel in an endoscope. U.S. Patent Application 20020077649 to Lasner, Michael illustrates a micro-surgical forceps having a handle and integral spring arms that are inter-connected at the end of the forceps remote from said blades in a tongue and groove arrangement that allows for operation of the forceps with a minimum of finger pressure.

U.S. Pat. No. 7,166,119 to Olsen illustrates a pair of scissors has two elements that are cross-wise rotationally movably assembled in a hinge, each of said elements consisting of a blade and an arm. U.S. Pat. No. 6,763,543 to Rivera illustrates a folding multipurpose tool incorporating a latch release mechanism including a lever, a cam, and a rocker-shaped grip body to easily effect release of a catch for holding knife or screwdriver blades extended. U.S. Pat. No. 6,592,603 to Lasner illustrates a micro-surgical forceps having a handle and integral spring arms that are interconnected at the end of the forceps remote from said blades in a tongue and groove arrangement that allows for operation of the forceps with a minimum of finger pressure. U.S. Pat. No. 5,875,553 to Geib, Jr., et al. illustrates a hair styling apparatus is provided which includes a hair thinning scissors and a hair cutting scissors releasable inter-connected to one another at a common pivot point. U.S. Pat. No. 5,745,997 to Berg, et al. illustrates a multi-purpose folding tool including a pair of folding scissors, in which a scissors blade is movable about a pivot shaft, between a stowed position and a deployed position in which a stop prevents the blade from moving further with respect to the handle because of pressure on the handle in the direction needed to close the scissors blades in a cutting stroke. U.S. Pat. No. 5,722,171 to Schmidt illustrates a hairdresser's scissors, with two scissor blades, connected to each other in articulated fashion by means of a single pivot, and two scissor handles, each of which displays two handle sections. U.S. Pat. No. 5,499,454 to Compton illustrates a buttonhole scissors comprising a first blade having a blunt distal end and an inner flat surface between a tapered cutting edge and an outer edge, a second blade having a pointed distal end and an inner flat surface between a tapered cutting edge and an outer edge. U.S. Pat. No. 5,307,548 to Engel illustrates a method of forming a tapered channel for a jack which uses less material comprising forming curved openings in the center portion of the channel and then stretching the middle portion of the channel so that it is tapered to produce a tapered channel. U.S. Pat. No. 4,473,947 to Ishida, et al. illustrates a pair of scissors including a receiving blade and a cutting blade which are rotate-ably coupled by means of a center bolt whose end is anchored to one of the two blade bodies. U.S. Pat. No. 4,473,945 to Nagel, Jr. illustrates an apparatus for cutting hair that is comprised of a triangular housing, enclosing open scissor blades, from whose opposing flat sides are projected hollow tubes, one having several fitted extensions, the other having affixed to it a flexible plastic hose, tapered at the end, so that it is insert able into a vacuum suction device, thus supplying suction so that, with the extension tube placed on the subject's scalp, hair will be drawn up, through the housing and between open scissor blades, where it is cut table at lengths dependent on the extensions used. None of the prior art illustrates a scissors that enables two blades of the scissors cross-over with a predetermined angle for clear cut with less frictions.

### SUMMARY OF THE INVENTION

Almost all of scissors developed up to now have blades that cross over each other without angle. Two blades of scissors overlap each other without any space between them from the first moment when the scissors is open to the last moment when the scissors is closed. Therefore, friction force between the two blades is maximum. It burdens a barber's finger to overcome the friction between the blades. If some gap is formed intently to reduce the friction force between the blades, hairs of a customer are inserted between the gaps. Then the hairs are not cut clearly or are not cut at all. Adding some lubricant to the blades may reduce the friction force but not desirable for human hair cut. It is a purpose of the current application to provide a human hair cutting scissors that causes less friction force between two blades than previous scissors by introducing one blade, which a central part that is tapered along the narrow axis of the blade and a hinge hole is developed thereon. The scissors according to current application enables a more clear cut of a human hair than scissors of prior art. The scissors according to current application has a specially designed first blade. The specially designed first blade has a central part, on which a hinge hole is developed. The central part is tapered along the narrow axis of the blade. The tapered central part of the first blade allows the second blade of the scissors to cross over the first blade with a predetermined angle. Therefore, the second blade's wide edge crosses over the first blade's wide edge with a pre-determined angle and sweeps wide surface of the first blade with an angle. Such angled cross over of the blades provides a more precise cut of customer's hair as a barber intended.

### BRIEF DESCRIPTION OF DRAWINGS

FIG. 1 is a perspective view of a scissors of prior art.

FIG. 2-a is a cross-sectional view of the scissors of prior art along line A-A′ in FIG. 1 seen from view point A″.

FIG. 2-b is a cross-sectional view of the scissors of prior art along line B-B′ in FIG. 1 seen from view point B″.

FIG. 3 is a perspective view of first embodiment of a scissors according to current application.

FIG. 4-a is a cross-sectional view of the first embodiment of the scissors according to current application seen along line C-C′ in FIG. 3 when the scissors is fully open seen from the view point C″.

FIG. 4-b is a side view of the first embodiment of the scissors according to current application seen along line D-D′ in FIG. 3 when the scissors is fully open seen from the view point D.″

FIG. 5-a is a cross-sectional view of the first embodiment of the scissors according to current application seen along line C-C′ in FIG. 3 when the scissors is partially closed seen from the view point C″.

FIG. 5-b is a side view of the first embodiment of the scissors according to current application seen along line D-D′ in FIG. 3 when the scissors is partially closed is seen from the view point D″.

FIG. 5-c is a cross-sectional view of the first embodiment of the scissors according to current application seen along line E-E′ in FIG. 3 when the scissors is partially closed seen from the view point E″.

FIG. 6-a is a cross-sectional view of the first embodiment of the scissors according to current application seen along line C-C′ in FIG. 3 from view pint of C″ when the scissors is totally closed.

FIG. 6-b is a side view of the first embodiment of the scissors according to current application seen along line D-D′ in FIG. 3 from a view point of D″ when the scissors is totally closed.

FIG. 7 is a cross-sectional view of second embodiment of the scissors according to current application seen along line C-C′ in FIG. 3 when the scissors is fully open seen from the view point C″.

FIG. 8 is a cross-sectional view of third embodiment of the scissors according to current application seen along line C-C′ in FIG. 3 when the scissors is fully open seen from the view point C″.

FIG. 9-a is a cross-sectional view of fourth embodiment of the scissors according to current application seen along line C-C′ in FIG. 3 when the scissors is totally closed, seen from the view point C″.

FIG. 9-b is a cross-sectional view of fourth embodiment of the scissors according to current application seen along line E-E′ in FIG. 3 as the scissors changes position from fully open state to totally closed state, seen from the view point E″.

FIG. 10 is a cross-sectional view of fifth embodiment of the scissors according to current application seen along line C-C′ in FIG. 3 when the scissors is totally closed, seen from the view point C″.

FIG. 11 is a cross-sectional view of sixth embodiment of the scissors according to current application seen along line C-C′ in FIG. 3 when the scissors is totally closed, seen from the view point C″.

FIG. 12 is a cross-sectional view of seventh embodiment of the scissors according to current application seen along line C-C′ in FIG. 3 when the scissors is totally closed, seen from the view point C″.

### DETAILED DESCRIPTION OF THE PREFERRED EMBODIMENT

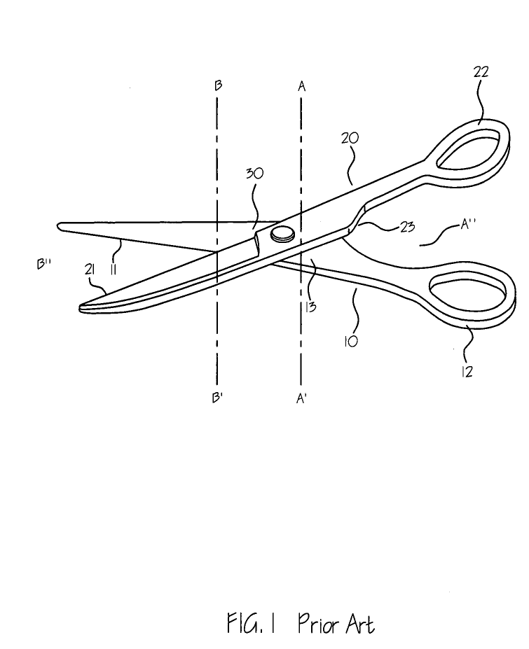

FIG. 1 is a perspective view of a scissors (1) of prior art. The scissors (1) usually comprised of a first member (10) and a second member (20) pivotally connected by a fastening member (30). The first member (10) is comprised of a first blade portion (11), a first handle portion (13) and a first ringlet (12). The second member (20) is comprised of a second blade portion (21), a second handle portion (23) and a second ringlet (22).

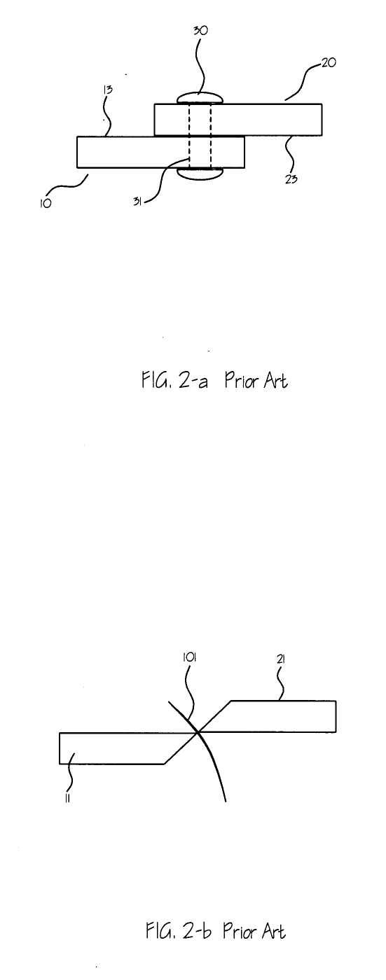

FIG. 2-a is a cross-sectional view of the scissors of prior art along line A-A′ in FIG. 1 seen from view point A″. Most of first member (10) and second member (20) of a scissors of prior art have flat surface from blade part to handle portion. Therefore, both of the members (10), (20) pass by maintaining flat contact of surfaces, which face each other.

FIG. 2-b is a cross-sectional view of the scissors of prior art along line B-B′ in FIG. 1 seen from view point B″. Therefore, hair (101) of a customer is cut by two blade portions of (11) and (21) while a little bit bent toward the first blade portion (11).

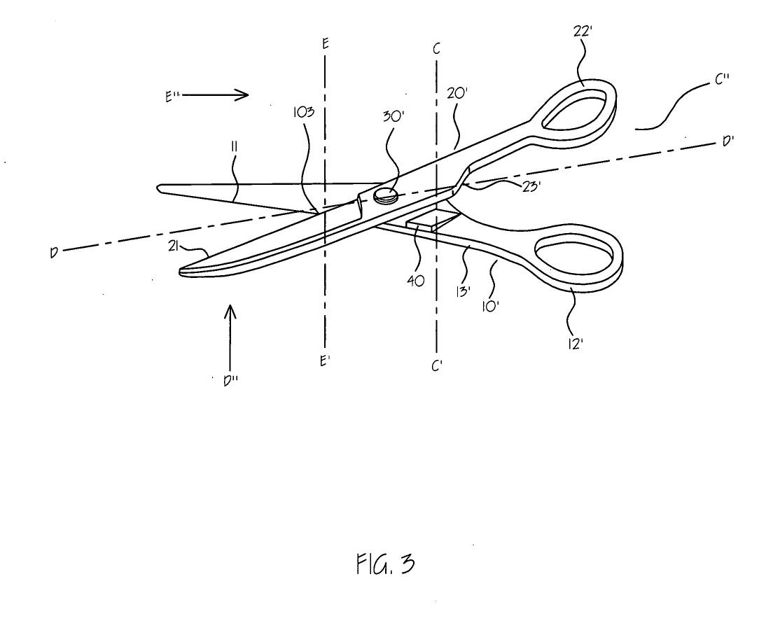

FIG. 3 is a perspective view of first embodiment of a scissors (2) according to current application. The scissors (2) according to current application is comprised of a first member (10′) and a second member (20′) pivotally connected by a fastening member (30′). The first member (10′) is comprised of a first blade portion (11′), a first handle portion (13′) and a first ringlet (12′). The second member (20′) is comprised of a second blade portion (21′), a second handle portion (23′) and a second ringlet (22′). A small tapered hump (40) is developed on the surface of the first handle portion (13′), which faces the second handle portion (23′).

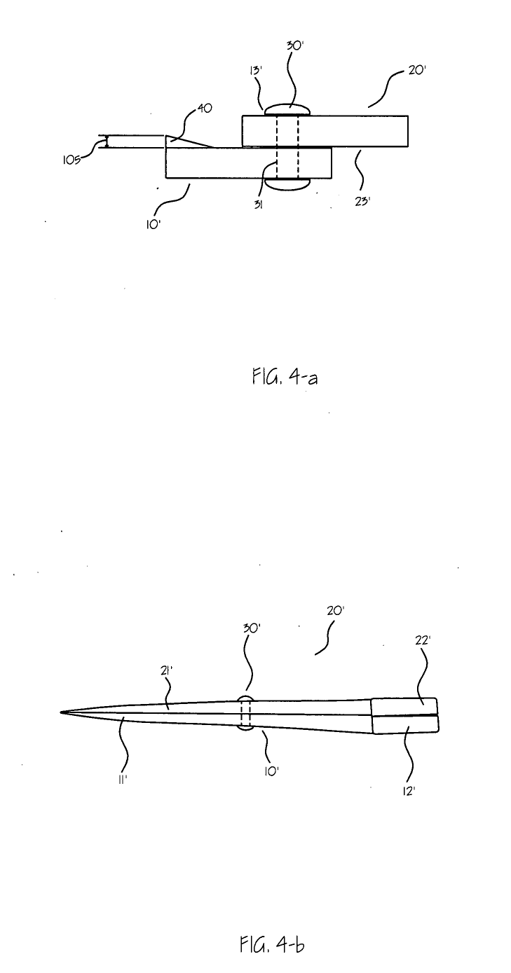

FIG. 4-a is a cross-sectional view of the first embodiment of the scissors (2) according to current application seen along line C-C′ in FIG. 3 when the scissors (2) is fully open seen from the view point C″. When the scissors (2) is fully open, the two members (10′) and (20′) contact horizontally. FIG. 4-b is a side view of the first embodiment of the scissors (2) according to current application seen along line D-D′ in FIG. 3 when the scissors is fully open seen from the view point D″. The two blade parts (11′) and (21′) locate horizontally.

FIG. 5-a is a cross-sectional view of the first embodiment of the scissors (2) according to current application seen along line C-C′ in FIG. 3 when the scissors is partially closed seen from the view point C″. At this moment, front face (25) of the second member (20′) ride over the small tapered hump (40).

FIG. 5-b is a side view of the first embodiment of the scissors (2) according to current application seen along the line D-D′ in FIG. 3 when the scissors (2) is partially closed seen from the view point D″. Since the second member (20′) is placed over the small tapered hump (40), the ringlet (22′) side of the second member (20′) is lifted and the opposite tip, the blade portion (21′), is lowered below the first blade portion (11′). Therefore, the two members (10′) and (20′) meet in a crossing position and contact each other at a point (103).

FIG. 5-c is a cross-sectional view of the first embodiment of the scissors according to current application seen along line E-E′ in FIG. 3 when the scissors is partially closed seen from the view point E″. Different from the FIG. 2-b, the two blade portions (11′) and (21 ′) contact each other at the point (103) with an angle (104). Therefore, all the cutting power from a user's hand is focused on the point (103) and cut the hair (101) of a customer more powerfully.

FIG. 6-a is a cross-sectional view of the first embodiment of the scissors (2) according to current application seen along line C-C′ in FIG. 3 when the scissors is totally closed, seen from a view point C″. As the scissor (2) is closed by a barber, the angle (104) between the two members (10′) and (20′) reaches a maximum. Desirable maximum value of the angle (104) between the members is less than 3 degrees. The maximum value of the angle (104) is determined by the height of the small tapered hump (40). Desirable maximum height (105) of the tapered small hump (40) is less than 2 mm, preferably 1 mm. At this moment, tips of the two blade portions (11′) and (21′) meet and rest of each member are separated with a space.

Since all the power from a barber's hand is concentrated on one point, where the two blade portions (11′) and (21′) cross each other with an angle (104) between their surface, actual force transferred to the hair (101) of a customer is greater than the case of scissors (1) of prior art. Therefore, the noble structure of a scissors (2) according to current application enables a barber doing a clean hair cut of a customer with less force and efforts.

FIG. 7 is a cross-sectional view of second embodiment of the scissors according to current application seen along line C-C′ in FIG. 3 when the scissors is fully open seen from the view point C″. In the second embodiment, the small hump (40′) is concavely tapered. In this case, the angle (104) between two blade portions (11′) and (21′) increases as the two blades of the scissors (2) approaches closing position. Then the power transferred to the contacting point (103) increases as the scissors (2) according to current application approaches a closed position. It is convenient to use a scissors (2) of the second embodiment when the hair (101) of the customer is thick.

FIG. 8 is a cross-sectional view of third embodiment of the scissors according to current application seen along line C-C′ in FIG. 3 when the scissors is fully open seen from the view point C″. In the third embodiment, the small hump (40′) is convexly tapered. In this case, the angle (104) between two blades portions (11′) and (21′) increases at the beginning. But, after it reaches a certain maximum, the value of the angle (104) decrease and becomes flat. Then the power transferred to the contacting point (103) reaches a maximum and decreases at a closed position. It is convenient to use a scissors (2) of the third embodiment when the hair (101) of the customer is thin.

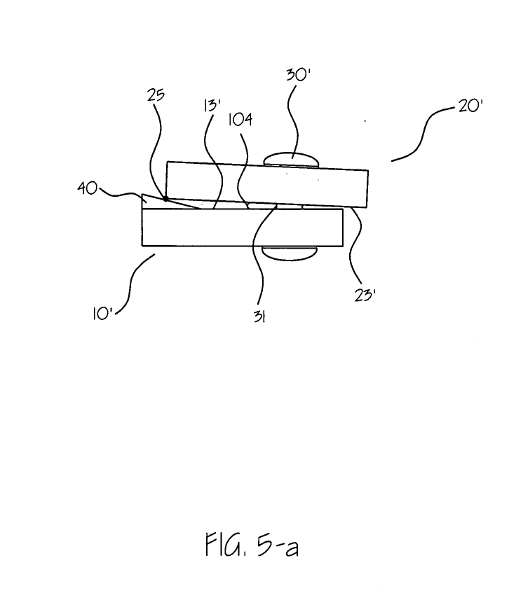

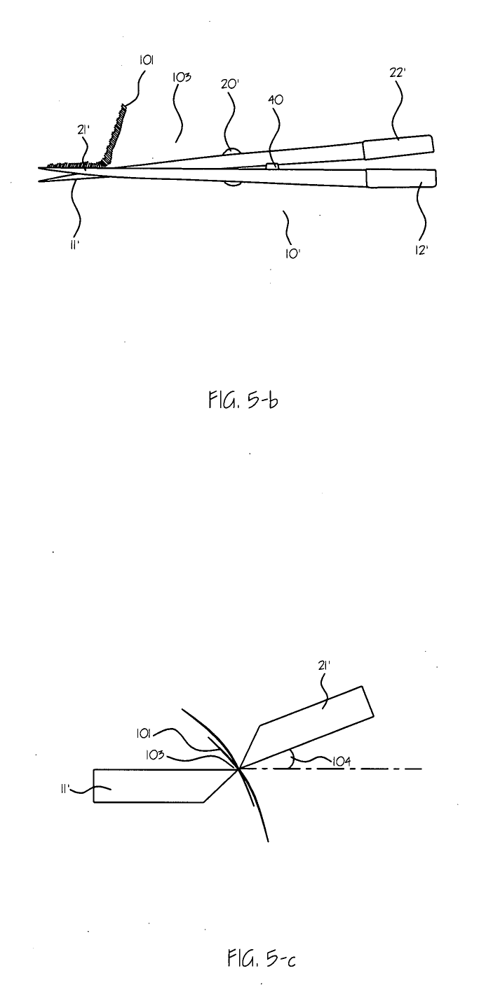

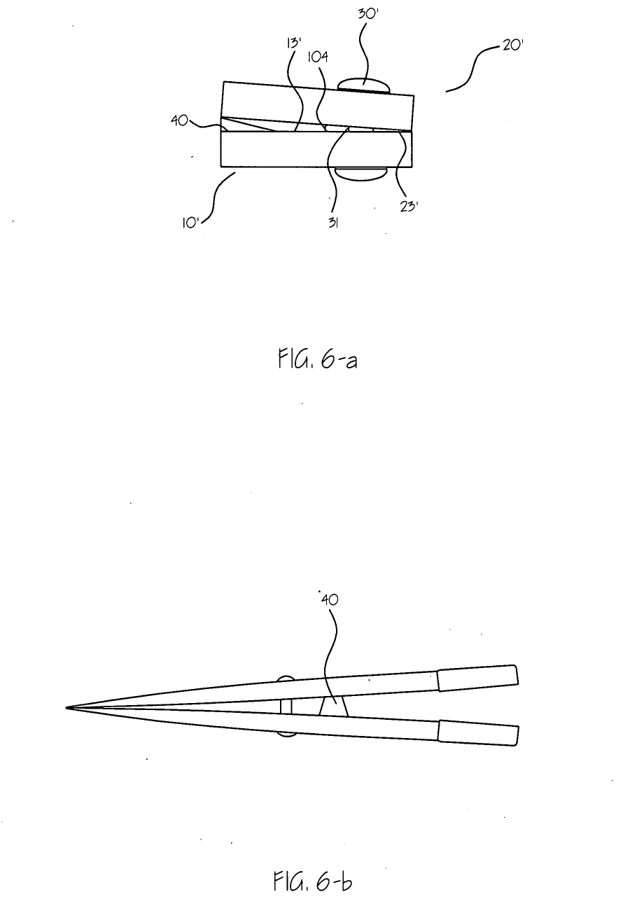

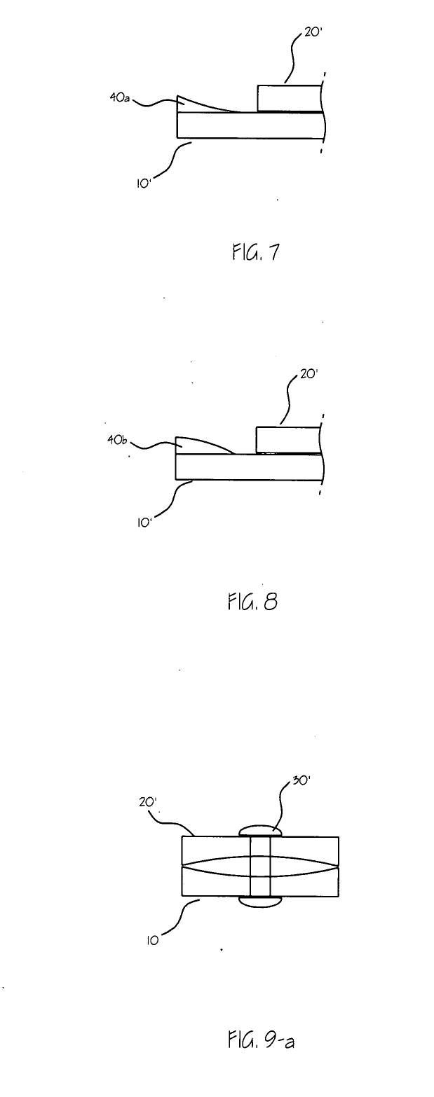

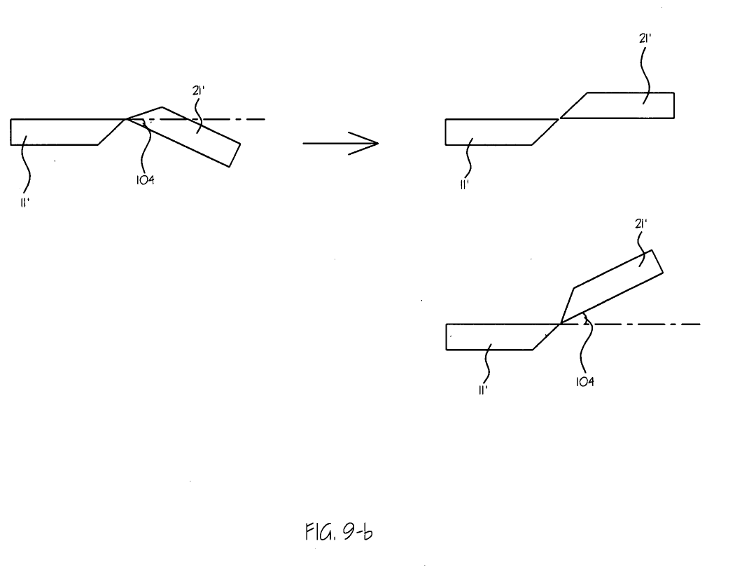

FIG. 9-a is a cross-sectional view of fourth embodiment of the scissors according to current application seen along line C-C′ in FIG. 3 when the scissors is totally closed, seen from the view point C″. In the fourth embodiment, the handle portions (13′) and (23′) of both of the members (10′) and (20′) are concavely carved.

FIG. 9-b is a cross-sectional view of fourth embodiment of the scissors according to current application seen along line E-E′ in FIG. 3 as the scissors changes position from fully open state to totally closed state, seen from the view point E″. In this case, the angle (104) between the two blades changes from negative to positive as the scissors (2) changes from open state to closed state.

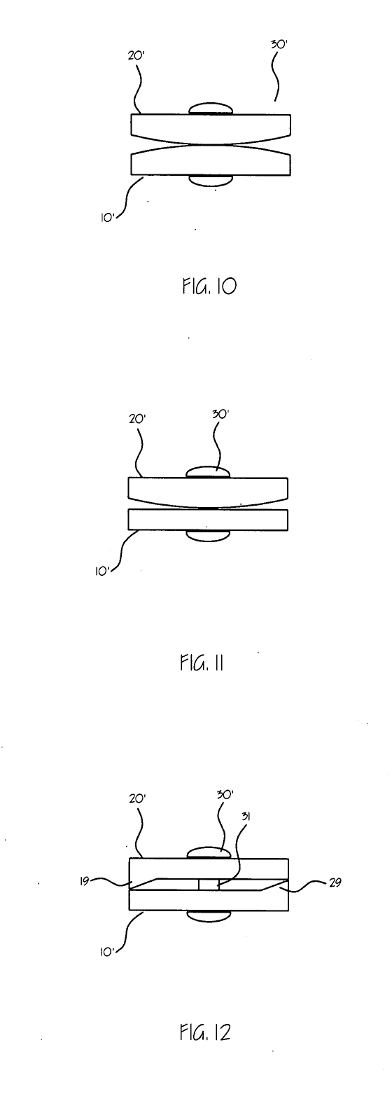

FIG. 10 is a cross-sectional view of fifth embodiment of the scissors (2) according to current application seen along line C-C′ in FIG. 3 when the scissors is totally closed, seen from the view point C″. In the fifth embodiment, the handle portions (13′) and (23′) of both of the members (10′) and (20′) are convexly carved. In this case, the angle (104) between the two blades also changes from negative to positive as the scissors (2) changes from open state to closed state, as shown in FIG. 9-b.

FIG. 11 is a cross-sectional view of sixth embodiment of the scissors (2) according to current application seen along line C-C′ in FIG. 3 when the scissors is totally closed, seen from the view point C″. In the sixth embodiment, the handle portion (23′) of both of the second member is convexly carved. In this case, the angle (104) between the two blades also changes from negative to positive as the scissors (2) changes from open state to closed state, as shown in FIG. 9-b.

FIG. 12 is a cross-sectional view of seventh embodiment of the scissors according to current application seen along line C-C′ in FIG. 3 when the scissors is totally closed, seen from the view point C″. In the seven embodiment, the handle portions (13′) and (23′) of both of the members (10′) and (20′) are trapezoidally carved. In this case, the angle (104) between the two blades also changes from negative to positive as the scissors (2) changes from open state to closed state, as shown in FIG. 9-b.

As described above, it is obvious that a person of ordinary skill in the field of this area can easily modify the structure of the handle portion of a scissors according to teaching of the current application.

What is claimed is

1. A scissors that is comprised of:
a first member that is comprised of
a first blade portion, and
a first handle portion, whereon a small tapered hump is developed on the surface that faces second handle portion, and
a first ringlet, and
a second member that is pivotally connected to the first member by a fastening member and is comprised of
a second blade portion, and
a second handle portion, and
a second ringlet.

2. A scissors in claim 1, wherein front face of the second member rides over the small tapered hump when the scissors is partially closed to allow the ringlet side of the second member being lifted and the opposite tip, the blade portion, being lowered below the first blade portion to make the first blade portion and the second blade portion meet in a crossing position and contact each other at one point with an angle.

3. A scissors in claim 1, wherein height of the small hump is 1 mm.

4. A scissors in claim 1, wherein an angle between the first member and the second member reaches maximum when the scissors is closed.

5. A scissors in claim 4, wherein the angle between the first member and the second member is 3 degrees.

6. A scissors in claim 1, wherein the small hump is concavely tapered.

7. A scissors in claim 1, wherein the small hump is concavely tapered.

8. A scissors in claim 1, wherein the small hump is convexly tapered.

9. A scissors in claim 1, wherein the handle portions of the first member and second member are concavely carved.

10. A scissors in claim 1, wherein the handle portions of both of the first members and the second member are convexly carved.

11. A scissors in claim 1, wherein the handle portion of both of the second member is convexly carved.

12. A scissors in claim 1, the handle portions of both of the first member and the second member are trapezoidally carved.
